(19) United States
(12) Patent Application Publication
(10) Pub. No.: US 2026/0105247 A1
(43) Pub. Date: Apr. 16, 2026

(54) SYSTEMS AND METHODS FOR AI-BASED ELECTRONIC DOCUMENT CREATION, CURATION AND MANAGEMENT

(71) Applicant: Shari PIRÉ, Las Vegas, NV (US)

(72) Inventor: Shari PIRÉ, Las Vegas, NV (US)

(21) Appl. No.: 19/333,883

(22) Filed: Sep. 19, 2025

Related U.S. Application Data
(60) Provisional application No. 63/706,101, filed on Oct. 11, 2024.
(60) Provisional application No. 63/756,931, filed on Feb. 11, 2025.

(51) Int. Cl. G06F 40/166; G06F 40/197; G06F 40/20; G06N 3/042; G10L 13/027

(52) U.S. Cl. CPC G06F 40/166; G06F 40/197; G06F 40/20; G06N 3/042; G10L 13/027

(57) ABSTRACT

Disclosed are systems and methods that provide a novel framework for drafting, revising, generating, sharing and/or collaborating on electronic documents via an AI-based knowledge-base(s) and AI provided document curation tools. The framework provides functionality for the integration of AI/ML models, particularly large language models (LLMs), into document analysis and editing processes. Accordingly, the disclosed computerized framework can provide customized and/or personalized advancements in the manner in which documents can be drafted, edited, revised and/or otherwise curated for the purposes of providing a formal output document that adheres to an author's preferred formatting and context/content settings/preferences.

### CROSS-REFERENCE TO RELATED APPLICATIONS

This application claims the benefit of priority from U.S. Provisional Application No. 63/706,101, filed Oct. 11, 2024 and U.S. Provisional Application No. 63/756,931, filed Feb. 11, 2025, which is are both incorporated herein by reference in their entirety.

### FIELD OF THE DISCLOSURE

The present disclosure relates to an electronic document creation, curation and management, and more particularly, to a decision intelligence (DI)-based computerized framework for drafting, revising, generating, sharing and/or collaborating on electronic documents via an artificial intelligence (AI)-based knowledge-base and AI provided document curation tools.

### SUMMARY OF THE DISCLOSURE

The current state of technology for analyzing and curating electronic documents, such as Microsoft Word® files, for example, is exemplified by tools like Litera™. Litera offers a suite of document comparison and analysis tools that primarily focus on legal and professional documents. These tools can compare different versions of a document, track changes, and provide some basic suggestions for formatting and style consistency. However, their capabilities are largely rule-based and lack the nuanced understanding that more advanced AI and machine learning (ML) models can provide.

Accordingly, as discussed herein, in some embodiments, the disclosed systems and methods provide functionality for the integration of AI/ML models, particularly large language models (LLMs), into document analysis and editing processes that represents a significant leap forward in the document creation and curation space/technology. Such models can offer more sophisticated, context-aware recommendations and suggestions that go beyond simple rule-based systems.

Accordingly, as provided herein, the disclosed systems and methods provide a computerized framework that can provide customized and/or personalized advancements in the manner in which documents can be drafted, edited, revised and/or otherwise curated for the purposes of providing a formal output document that adheres to an author's preferred formatting and context/content settings/preferences.

It should be understood that while the discussion herein may focus on text-based electronic documents (e.g. Microsoft Word files), it should not be construed as limiting, as any type of electronic document, file, object or item, which can include any type of content, inclusive of, but not limited to, audio, video, text, images, multi-media, and the like, can be analyzed and curated via the disclosed systems and methods without departing from the scope of the instant disclosure.

According to some embodiments, a method is disclosed for a DI-based computerized framework for drafting, revising, generating, sharing and/or collaborating on electronic documents via an AI-based knowledge-base(s) and AI provided document curation tools. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for drafting, revising, generating, sharing and/or collaborating on electronic documents via an AI-based knowledge-base(s) and AI provided document curation tools.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed in more detail below, the disclosed framework can process an electronic document via a set of operational steps that are performed, at least with usage, of a curated and/or personalized machine learning model, as discussed herein. In some embodiments, such model can ingest and process the document's content. In some embodiments, this can involve parsing the text, understanding its structure, and identifying various elements such as headings, paragraphs, lists, tables, and any embedded media. The model can operate to comprehend the document's overall purpose, tone, sentiment, and intended audience, which it can infer from the content and any metadata provided.

According to some embodiments, once the document is processed, the disclosed model (e.g., engine 200, as discussed infra) can perform a multi-faceted analysis. For example, in some embodiments, the model can evaluate the document's coherence and flow, assessing how well ideas are connected and whether the structure supports the overall message. The model can identify areas where clarity could be improved, suggesting rewrites or reorganization of content. The model can also check for consistency in terminology, style, and voice throughout the document.

In some embodiments, in terms of grammar and mechanics, such model can go beyond traditional spell-checkers and grammar tools. That is, for example, the model can understand context and nuance, suggesting more natural-sounding alternatives to awkward phrasing. In some embodiments, the disclosed model and associated operations can identify and correct subtle grammatical errors that might escape rule-based systems, such as agreement issues in complex sentences or misused idioms.

In some embodiments, in relation to the document's style and tone, the model can analyze the document against the author's desired settings or industry-specific guidelines. For example, the author's settings can be based on a training of the model based on a local and/or network-based knowledge-base (repository of documents), which can be the author's documents or a set of documents by other authors that the author of the document intends to mimic. In some embodiments, the model can suggest adjustments to make the language more formal or casual, more technical or accessible, depending on the target audience and/or type of document. The model can also identify overused words or phrases and offer varied alternatives to enhance the writing's richness, which can also be based on the document's audience and/or type.

In some embodiments, the model can also provide content-based suggestions. That is, for example, the model can operate to identify areas where additional information and/or clarification can be beneficial, suggesting potential topics to expand upon. Conversely, the model can highlight redundant or tangential information that could be trimmed for conciseness. In some embodiments, the model can generate relevant examples and/or analogies to illustrate complex points, enhancing the document's effectiveness in conveying its message.

In some embodiments, for documents with specific requirements, such as legal documents, academic papers or technical reports, the disclosed model can ensure compliance with formatting guidelines, citation styles, and structural conventions, inter alia. In some embodiments, the model can operate to check for proper citation usage, suggest additional relevant sources, and ensure that all necessary sections (e.g., abstracts, methodologies, conclusions, and the like) are present and/or appropriately developed.

In some embodiments, in relation to data and fact-checking, the disclosed model can operate to cross-reference information in the document based on a selected knowledge base(s), and proceed to flagging potential inaccuracies and/or outdated information. In some embodiments, the model can suggest updates or provide links to more current sources, providing functionality for maintaining the document's accuracy and relevance.

In some embodiments, in collaborative environments, the disclosed model can operate to analyze each contributors'writing styles and suggest edits to create a more cohesive voice throughout the document. In some embodiments, the model can also summarize changes made by different authors, thereby providing a clear overview of how the document has evolved over time.

Accordingly, as discussed herein, the framework's use of advanced AI/ML and LLM models for document analysis and curation can provide an improved comprehensive, nuanced and context-aware approach to document editing, thereby enabling users and/or word-document processing application with capabilities for providing sophisticated recommendations across various aspects of writing. Accordingly, an increase in efficiency and quality of document creation and editing processes across numerous fields and industries can be realized.

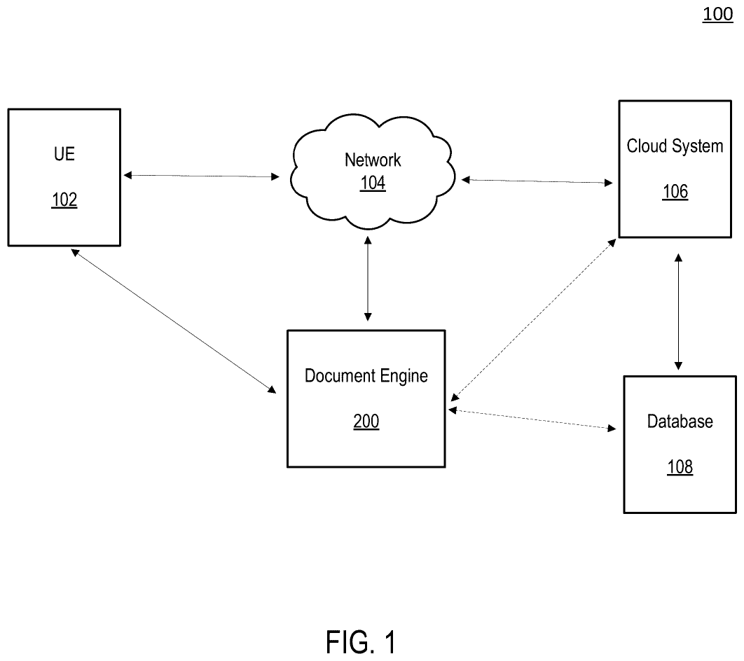

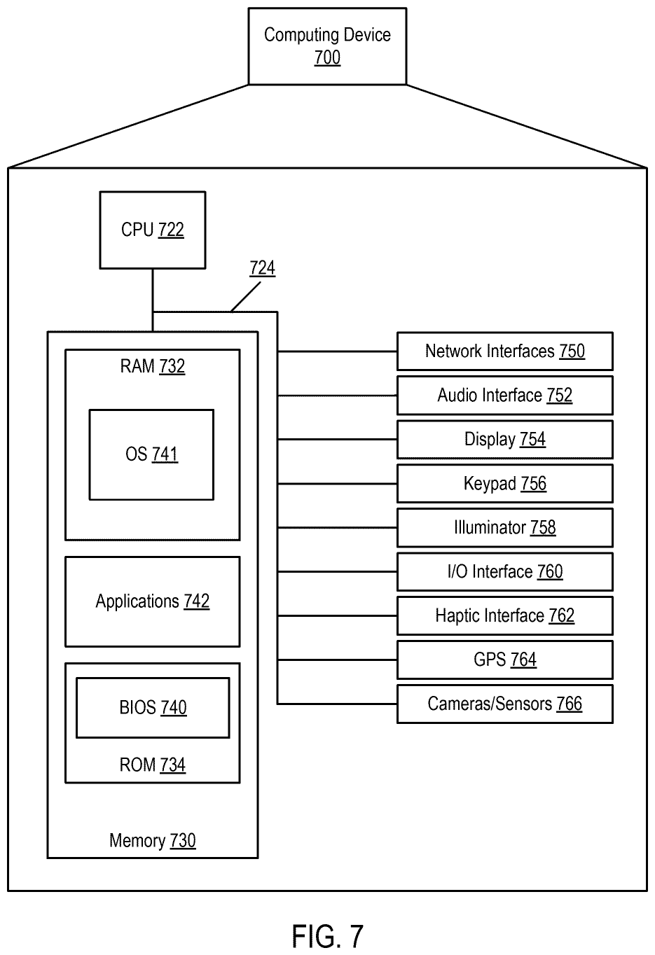

With reference to FIG. 1, system 100 is depicted which includes user equipment (UE) 102 (e.g., a client device, as mentioned above and discussed below in relation to FIG. 7), network 104, cloud system 106, database 108 and document engine 200. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver. For example, UE 102 can be a smart phone with applications installed and/or accessible thereon. In another non-limiting example, UE 102 can correspond to a laptop of an employee of an organization that has an Internet Service Provider (ISP) and/or communication service provider (CSP) account with an ISP/CSP provider.

In some embodiments, a peripheral device (not shown) can be connected to UE 102, and can be any type of peripheral device, such as, but not limited to, a wearable device (e.g., smart ring or smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a smart phone, smart ring, smart watch or other wearable device that connectively pairs with UE 102, which is a user's laptop.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the sleep management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, and the services and applications provided by cloud system 106 and/or document engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

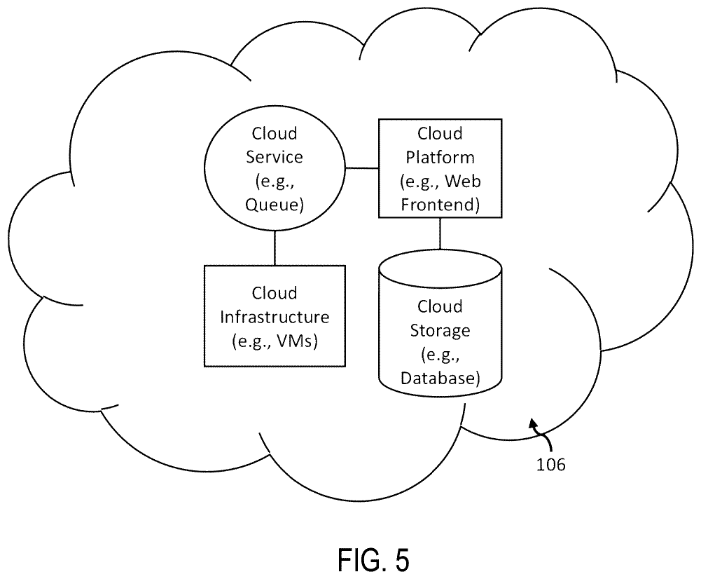

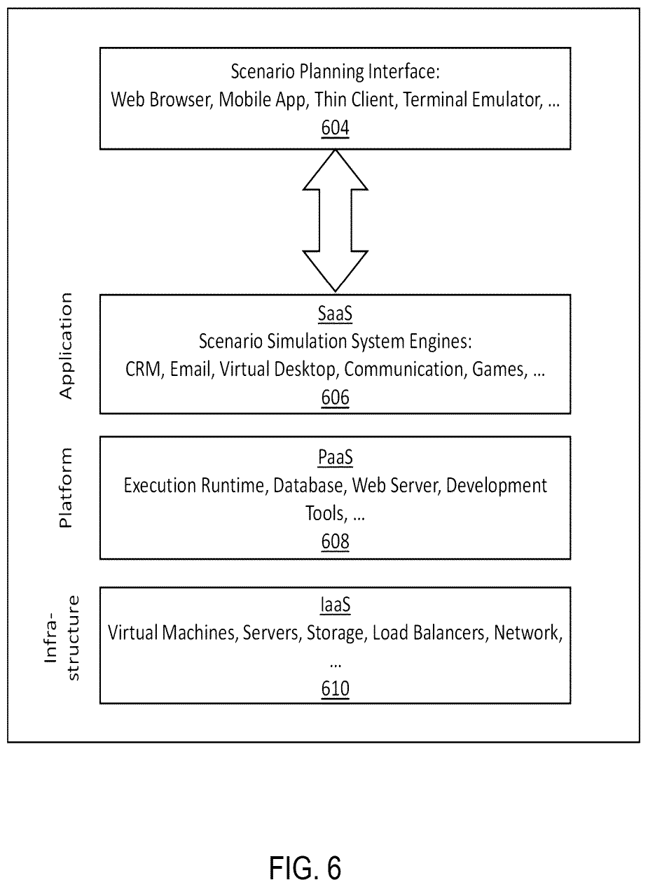

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. In some embodiments, the architecture can also be network as a service (Naas). FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository Document engine 200, as discussed above and further below in more detail, can include components for the disclosed functionality. According to some embodiments, document engine 200 may be a special purpose machine or processor, and can be hosted by a device on network 104, within cloud system 106, and/or on UE 102. In some embodiments, engine 200 may be hosted by a server and/or set of servers associated with cloud system 106.

According to some embodiments, as discussed in more detail below, document engine 200 may be configured to implement and/or control a plurality of services and/or microservices, where each of the plurality of services/microservices are configured to execute a plurality of workflows associated with performing the disclosed security management. Non-limiting embodiments of such workflows are provided below.

According to some embodiments, as discussed above, document engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 and/or other devices over network 104 from cloud system 106. In some embodiments, engine 200 may be configured and/or installed as an augmenting script, program or application (e.g., a plug-in or extension) to another application or program provided by cloud system 106 and/or executing on UE 102.

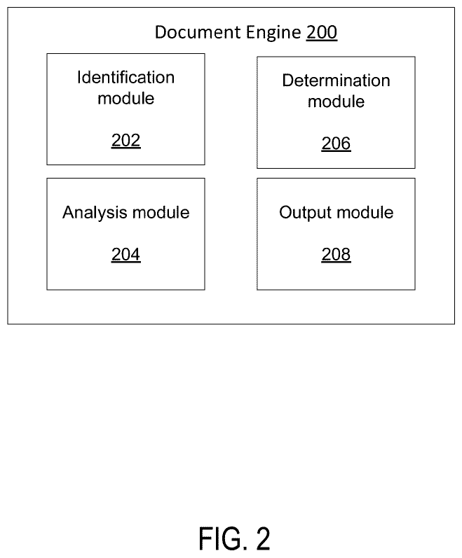

As illustrated in FIG. 2, according to some embodiments, document engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

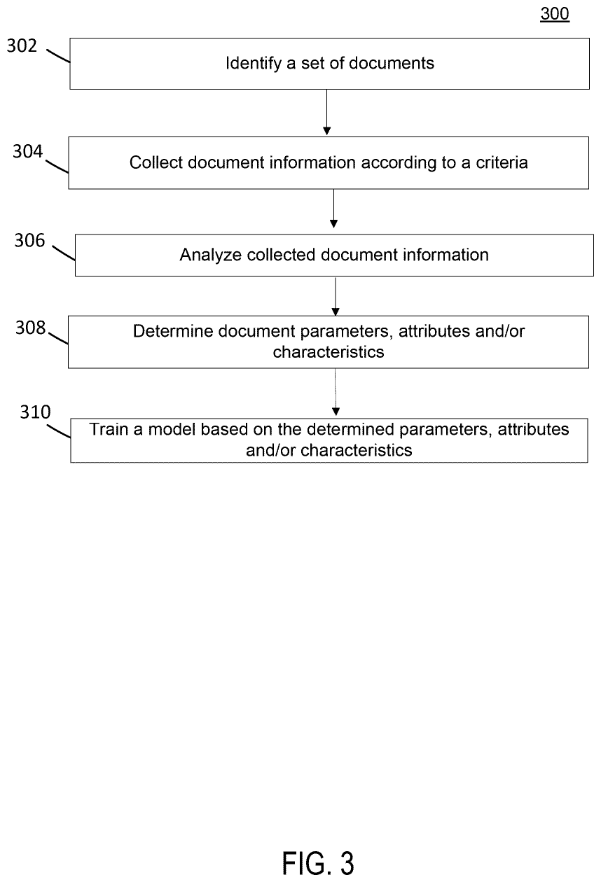

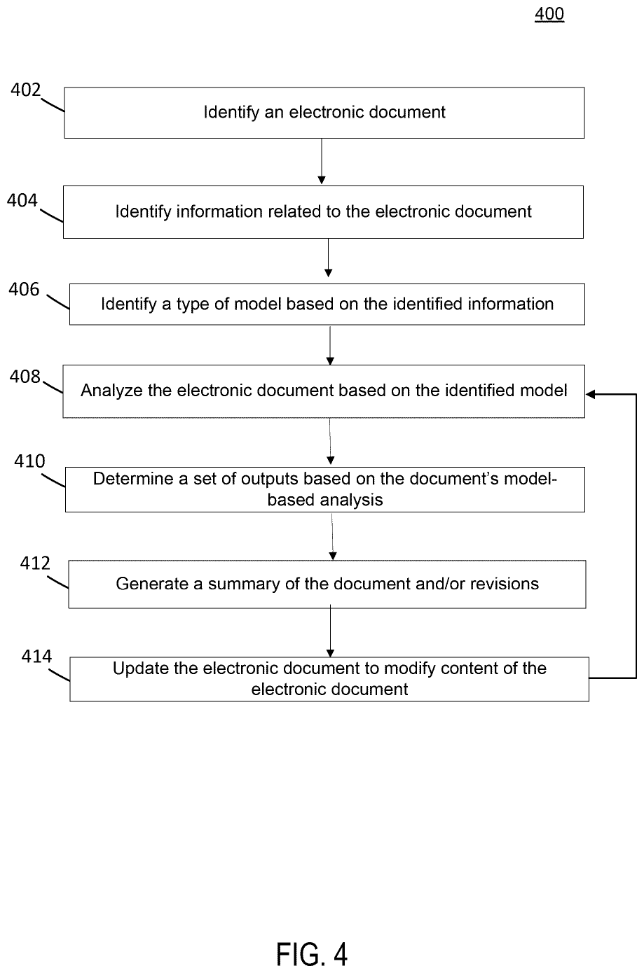

Turning to FIG. 3, Process 300 provides non-limiting example embodiments for the disclosed document management framework. According to some embodiments, Process 300 provides non-limiting embodiments for mechanisms for training specially implemented computer models. For example, legal documents can use a specific model; construction/CAD documents can use another type of specifically trained model; and the like, as discussed herein. As discussed below at least in relation to Process 400 of FIG. 4, such trained models can be specifically called and leveraged for specific runtime environments.

By way of example, according to some embodiments, a specifically trained model for analyzing particular types of documents, such as legal contracts or academic papers, offers significant advantages over general-purpose language models. Such a specialized model, as evidenced via the processing in Process 300 discussed herein, is immersed in the nuances, conventions, and specialized vocabulary of its target domain, allowing it to provide more accurate and relevant insights during document review and revision.

By way of a non-limiting example, for legal documents, a tailored model can understand complex legal terminology, recognize standard clauses, and be aware of jurisdiction-specific requirements. In some embodiments, such model can identify potential loopholes, inconsistencies, or ambiguities that might be overlooked by a general model or human reviewer. For example, contract analysis, the model could compare terms against industry standards, flag unusual provisions, and ensure compliance with relevant laws and regulations.

In another non-limiting example, in academic writing, a specialized model can be familiar with discipline-specific formatting requirements, citation styles, and common structural elements. Such model can assess the logical flow of arguments, evaluate the appropriateness of methodology descriptions, and suggest areas where additional evidence or explanation might be needed. Such a model could also help ensure proper attribution and identify potential issues with plagiarism or self-plagiarism.

As provided herein, with more detail via the steps of Process, discussed infra, operations via engine 200 for training such model(s) can involve exposure to large and/or tailored corpora of high-quality, domain-specific documents. This allows the model to learn not just the language patterns but also the underlying logic and best practices of the field. In some embodiments, such training data can be specific to the author, selected by the author and/or generated by the author (e.g., the author's previous documents of a similar type). Accordingly, fine-tuning on annotated datasets with validated corrections and improvements further enhances the model's ability to provide relevant and accurate suggestions.

Moreover, in some embodiments, as discussed below in relation to Process 400 of FIG. 4 (as per the feedback loop from Step 418 to Step 408), a model's implementation, as it is used in practice, can realize continuous feedback, which can be incorporated to refine/update its performance. This iterative improvement process allows the model to stay current with evolving standards and practices in its specialized field. Thus, in some embodiments, this can result is a powerful computerized tool that can significantly streamline the document review and revision process, catching errors and suggesting improvements that even experienced professionals might miss, while, in some embodiments, still allowing human experts to make final decisions based on their judgment and specific context.

According to some embodiments, Steps 302 and 304 of Process 300 can be performed by identification module 202 of document engine 200; Step 306 can be performed by analysis module 204; Step 308 can be performed by determination module 204; and Step 310 can be performed by output module 208.

According to some embodiments, Process 300 begins with Step 302 engine 200 identifying a set of documents. As discussed herein, such documents can be any type of electronic document, record and/or file (or object, item and the like), and the like. For example, the documents can be, but are not limited to, Word® or Excel® documents, purchase receipts, portable document formats (PDFs), web pages, database records, text messages, social media postings, emails, information on SharePoint sites, and the like. As discussed above, such documents can include data and/or metadata, which can be in the form of text, images, video, audio, multi-media, program code, and the like, and/or any other type of content that can be included, associated with and/or derived from an electronic document.

As mentioned above, it should be understood that while the discussion herein will focus on electronic documents being word processing documents (e.g., Microsoft Word documents), it should not be construed as limiting, as one of ordinary skill in the art would readily recognize that other types of documents can be utilized without departing from the scope of the instant disclosure. Moreover, while such documents will be discussed with reference to including text content, it should not be construed as limiting, as one of skill in the art would also recognize that any type of content can be included therein, which can be subject to the review and curation as discussed herein.

In some embodiments, the set of documents identified in Step 302 can be identified based on a criteria or request, which can correspond to, but not be limited to, an identifier (ID), author ID, reviewer ID, document type, category of content, date, location, time, length, language, tense, prose, tone, sentiment, age appropriateness, context, and the like, or some combination thereof. In some embodiments, the set of documents, which serve as training data for a model, as discussed herein, can be generated and/or retrieved from a data repository, which can be local, remote and/or some combination thereof (e.g., a web-based wiki, a repository of legal documents filed with a court, local documents stored on a computer drive or network hosted drive, and the like).

In Step 304, engine 200 can collect information related to such documents, which can also be based on a criteria. Such criteria can correspond to filtering such documents and/or extracting information from such identified documents as they pertain to types of information within and/or derivable from the documents. For example, such criteria can correspond to identifying information related to, but not limited to, author ID, reviewer ID, document type, category, date, location, time, length, language, tense, prose, tone, sentiment, age appropriateness, context, and the like, or some combination thereof. For example, Step 304 can involve engine 200 parsing each identified document in the set of documents (from Step 302) to identify portions of the documents that relate to a specific legal clause, terminology, word usage, sentiment, and the like.

In some embodiments, such information collection can correspond to parsing the documents to determine the data and/or metadata, which can involve extracting the document body (e.g., content) from the metadata, such that the content can be analyzed via subsequent steps in Process 300. For example, the criteria can involve identifying non-template text from documents (e.g., some documents are subject to specific types of formatting or document object models (DOMs); therefore, the DOMs, for example, can be used to identify the user-generated content compared to the computer-generated content in such documents.

In Step 306, engine 200 can analyze the collected information from the documents. As discussed above, such information can correspond to the compiled/collected text in each document, which can be the entirety of the text/content from such documents and/or a portion as filtered and identified, as discussed above. According to some embodiments, engine 200 can implement any type of known or to be known computational analysis technique, algorithm, mechanism or technology to analyze the collected document information from Step 304 (and/or Step 302).

In some embodiments, engine 200 may include a specific trained AI/ML model, a particular ML model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage an LLM(s), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the documents and/or corresponding document information, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine document parameters, attributes and/or characteristics, which can be referred to as “features.” Such features can indicate a pattern, which can be tied to how an author typically (at least a threshold amount of times from the set of documents) uses, for example, a tone, word choice, sentence choice, particular writing style, sentiment, legal clause, type of content, particular content (e.g., mentions a specific entity as a point of reference), addresses a particular audience, and the like. Such patterns can be correlated to how they are used within such documents, as defined by such features.

And, in Step 310, engine 200 can train an AI/ML and/or LLM model based on such derived/determined features. For example, a model to be used for legal documents to be prepared by and/or for an author can be trained on learned features from previously prepared documents (e.g., identified set of documents in Step 302) by the author. Such training can involve any type of known or to be known mechanism for training a model, which can include, but is not limited, supervised learning, unsupervised learning, reinforcement training, generative learning, and the like, or some combination thereof.

Thus, at the conclusion of Step 310, Process 300 has enabled a specifically trained model for use in a runtime environment. As provided below, such training can occur upon uploading and/or identifying a document for review, such that a specific model can be curated and applied at runtime for specific document(s) and/or author/reviewer requests.

Turning to FIG. 4, Process 400 provides non-limiting example embodiments for the deployment and/or implementation of the disclosed document management framework.

According to some embodiments, Steps 402-406 of Process 400 can be performed by identification module 202 of document engine 200; Step 408 can be performed by analysis module 204; Step 410 can be performed by determination module 206; and Steps 412 and 414 can be performed by output module 208.

According to some embodiments, Process 400 begins with Step 402 where engine 200 can identify an electronic document (also referred to as a document, used interchangeably). Similar to the discussion above respective to Step 302, the document is a text-based, word processing document, in a non-limiting example embodiment.

According to some embodiments, the identified document is a prepared and/or in-progress prepared draft of a final document for which revisions and/or feedback is being requested. For example, user Jill is drafting a legal memorandum about topic X for her supervisor user Jane. Jill has finished her first draft, and would like feedback on where to expand, change and/or if it is complete.

In Step 404, engine 200 can identify information related to the electronic document. Such information can involve engine 200 receiving data/metadata related to the document, which can include, but is not limited to, subject, topic, author ID, target audience, reviewer, document type, and the like. In some embodiments, such information can be provided by the author or another user. In some embodiments, such information can be derived via engine 200 inputting the document (or information related to the document, for example, an abstract, or other portion of the document) into an AI/ML and/or LLM, as discussed above. In some embodiments, such information can be determined, derived, or otherwise identified by engine parsing the document and extracting such information.

In Step 406, engine 200 can identify or determine a type of model to be used for analyzing the document. Such model identification can be based on the identified information. For example, if the information indicates that the document is related to topic X, then engine 200 can identify/call a model that is trained for topic X, or a broader category that includes topic X (e.g.., if topic X relates to force majeure clauses in contracts, the model can be a model trained on contract law in a specific state, for example). In another example, the model can be trained based on past documents prepared by reviewer Jane. Accordingly, how, in what manner and for what purpose the model is trained is discussed above, which can involve training the model for a single or plurality of criteria, as discussed in Process 300, discussed infra.

In some embodiments, as discussed above, Step 404 can involve calling Process 300 to generate a trained and/or updated model specific to the identified information (from Step 404) in the document (in Step 402).

In Step 408, engine 200 can perform analysis operations on the document, which can involve inputting the document into the AI/ML and/or LLM model identified in Step 406. Such AI/ML and/or LLM analysis can be performed in a similar manner as discussed above respective to Step 306 of Process 300. Accordingly, the model in Step 406 can be executed to analyze the document, which can perform, but is not limited to, proofreading, grammar checks, sentiment analysis, tone analysis, and the like, which are all tied to, or driven by, the manner in which the model was trained, as discussed above.

In Step 410, engine 200 can determine a set of outputs based on the document's model-based analysis. As provided herein, one or more of such outputs can be generated, which can include, but is not limited to, generating a recommendation for editing the document (e.g., revisions, spelling, grammar, changing sentences structure), recommendations for adding and/or removing content from the document, and the like. For example, engine 200 can output recommendations that recommend changing the terms or sentence structure used for a specific section to more align with the manner the target audience (e.g., reviewer Jane) prefers (or has used in her past documents of a similar type).

In some embodiments, such recommendations can cause modifications to the document, which can be color coded, involve changes in text display (e.g., font size, shape, emphasis (e.g., bold, underline, italics), and the like), and the like. Such modifications can cause a visible change to the document. Such modifications can, in some embodiments, cause a modification to the document in that it changes its format structure - for example a new version is created and stored locally on the device performing the review; and/or a new version is created and stored on the cloud which is executing the review/document application (e.g. web-based Microsoft Word version).

In some embodiments, the recommendations can be automatically performed, whereby a notification can be sent to the author (e.g., Jill) to let them know such changes have been made. In some embodiments, a notification, which can include information indicating the proposed/recommended and/or automatically performed changes, can be sent to the target audience (e.g., reviewer Jane).

In Step 412, engine 200 can generate a summary of the document and/or revisions. Such summary can be a newly created document, data structure or file, and/or can be a newly created form of data that can be annotated and/or incorporated into the document for display as an annotation (e.g., in a sidebar, as an overlay, as selectable/interactive text, for example). Such summary, which can be generated via execution of the AI/ML and/or LLM model, can provide a context of the set of outputs (from Step 410), which can provide a reasoning and explanation as to why certain changes were recommended and/or performed. For example, an LLM can analyze the electronic document and recommendations for revisions, and provide a short paragraph (e.g., 50-150 words threshold range) that contextually represents the suggested/performed changes. In some embodiments, the model called and executed in Steps 406 and 408 can perform such summary generation.

In some embodiments, as discussed above, such summary can be provided to engine 200 so that the AI/ML and/or LLM model (from Step 406) can be further trained, discussed supra.

And, in Step 414, engine 200 can perform actions to update/modify the electronic document to modify content of the document. Such input, which can be provided by engine 200, the author (e.g., user Jill) and/or the reviewer (e.g., user Jane), can provide, but is not limited to, instructions for accepting recommendations (and/or automatically performed actions), instructions for modifying such recommendations, instructions for modifying other portions of the document not subject to the proposed recommendations (in Step 410), and the like, or some combination thereof. Accordingly, Step 414 can result in an automatically curated document that involves automatically recommended actions, and performance of such actions (e.g., either automatically, or at least based on feedback), which maps to a desired output of the document upon its request for generation.

In some embodiments, a new version of the document is created; in some embodiments, the modified version of the document is an altered version, whereby, in some embodiments, read/write controls can be transferred from/to the author and/or reviewer. For example, upon performing Step 402, write controls can be transferred from the author (e.g., Jill) to engine 200 (and/or reviewer Jane), whereby upon performance of Step 414, such write controls can be transferred back to the author (e.g., Jill) for finalizing and/or performing further drafting of the document. Thus, upon Step 414, engine 200 can proceed back to step 408 for which further analysis of further updates provided by the author can be performed until the document is complete.

In some embodiments, as discussed above, information related to the updating of the document, as discussed herein, which include information related to the original document, the recommended revisions, and the accepted revisions (as well as declined revisions), can be provided to engine 200 so that the AI/ML and/or LLM model (from Step 406) can be further trained, discussed supra.

In some embodiments, the framework (e.g., engine 200, as discussed supra) can analyze a document by leveraging machine learning models trained on extensive datasets, including existing documents, style guides, and materials authored by preferred individuals. This analysis allows the framework to identify areas where a document can be improved in terms of clarity, grammar, coherence, and adherence to a given author's unique style. The processing application utilizes natural language processing (NLP) techniques to assess the text structure, word choice, sentence complexity, and overall tone to align with the expected standards.

In some embodiments, the framework can determine recommended edits based on several factors. The framework may compare the document against a database of similar high-quality documents, extracting patterns and stylistic nuances that should be incorporated. Additionally, machine learning algorithms can be trained to detect common mistakes or areas for enhancement, offering context-based recommendations. These suggestions can include rewording complex sentences, improving transitions between paragraphs, refining word choices, and enhancing clarity by eliminating redundancy or ambiguity. By analyzing patterns from a preferred author's works, the framework can tailor its recommendations to ensure consistency with that author's voice and intent.

In some embodiments, the framework can output these recommendations in multiple formats, allowing users to engage with the analysis in a way that best suits their workflow. The framework may present recommendations in real-time through an interactive document editor, where comments appear as annotations alongside the text. Users can review suggested changes inline, accept or reject them individually, or apply bulk changes based on predefined preferences. Additionally, a summary report could be generated, detailing the key areas of improvement with categorized suggestions, which can be exported as a document, email, or formatted report.

In some embodiments, the framework can extend its output capabilities beyond on-screen text by delivering an audio-based review of the document. This approach is particularly useful for users who prefer to consume information in an auditory format, such as during a commute or while performing other tasks. The framework can convert the analysis and recommendations into synthesized speech, utilizing advanced text-to-speech (TTS) technology to create a natural-sounding narrative. The audio output may be structured to provide an overview of the document's strengths and weaknesses before diving into specific recommendations, ensuring a coherent and structured listening experience.

In some embodiments, the framework can allow users to schedule an audio review, generating and delivering the spoken analysis at a convenient time. Users may set preferences for daily or weekly audio summaries, ensuring they receive feedback at regular intervals. The framework can provide an option to download these audio files in common formats such as MP3, enabling offline access. Additionally, users may request an on-demand audio analysis, which would generate a fresh synthesis of recommendations based on the latest document version.

In some embodiments, the framework can customize the audio output based on user preferences. For example, the user may choose the level of detail included in the narration—whether they prefer a high-level summary or a deep dive into each suggested revision. The framework may also offer options to adjust the voice characteristics, including tone, speed, and accent, to enhance the listening experience. Interactive voice commands could allow users to navigate the feedback, skipping sections or replaying specific recommendations for clarity.

In some embodiments, the framework can integrate with personal assistant devices and mobile applications to ensure accessibility. Users may listen to document reviews through smart speakers, in-car infotainment systems, or mobile apps that support voice feedback. This seamless integration allows professionals to engage with document analysis hands-free, making it easier to review and implement feedback even when they are away from their primary workstation.

In some embodiments, the framework can enhance user engagement by incorporating contextual explanations in the audio feedback. Instead of merely suggesting edits, the framework may provide reasoning behind each recommendation, explaining grammar rules, stylistic preferences, or logical improvements. This additional context helps users understand the rationale behind changes, improving their writing skills over time. Furthermore, interactive features could allow users to ask follow-up questions via voice commands, requesting further clarification or alternative suggestions.

In some embodiments, the framework can technically implement voice output through multiple layers of processing. First, the framework preprocesses the textual analysis and structures the feedback logically. The text-to-speech engine then converts this structured feedback into spoken audio, applying natural language processing enhancements to ensure fluidity and natural pronunciation. Advanced speech synthesis models, such as neural TTS, can be utilized to mimic human intonation, making the feedback sound more engaging and less robotic.

To further enhance the usability of the audio output, the framework can implement an adaptive pacing mechanism, where the speech speed dynamically adjusts based on complexity. For instance, complex grammatical explanations can be delivered at a slower rate, while simple suggestions are spoken at a normal conversational speed. This ensures that listeners can fully absorb the information without feeling overwhelmed or rushed. Additionally, the framework can integrate background noise reduction and audio enhancement techniques to ensure clarity when played in various environments, such as inside a vehicle or on a mobile device.

Another technical aspect of the voice output framework is the implementation of structured tagging and segmentation. The framework can break down recommendations into distinct categories, such as “Grammar Corrections,” “Structural Enhancements,” and “Stylistic Adjustments. ” These segments allow users to skip to relevant sections when listening to long-form audio feedback, improving efficiency and accessibility. Furthermore, users may have the option to pause, rewind, or speed up sections using voice commands, allowing for interactive engagement with the content.

To accommodate different listening preferences, the framework may support multi-voice narration, where different types of edits are spoken by distinct voices. For example, a female voice might narrate structural changes, while a male voice provides grammatical suggestions. This differentiation aids comprehension and reduces listener fatigue, making it easier to process large amounts of feedback.

In some embodiments, the framework can adapt to various document types and purposes, whether it be business reports, academic papers, creative writing, or legal documents. The framework can recognize domain-specific terminology and apply appropriate editing standards based on the context. For example, an academic document may require a formal tone with proper citations, whereas a marketing copy might emphasize persuasive language and concise messaging. The framework's ability to differentiate between these contexts ensures that recommendations remain relevant and effective.

In some embodiments, the framework can employ artificial intelligence to track a user's writing progress over time, identifying recurring issues and providing tailored guidance. By analyzing historical document revisions, the framework can generate personalized learning insights, highlighting improvements and persistent challenges. This feedback loop allows users to refine their writing skills systematically, ultimately reducing the need for extensive edits in future documents.

In some embodiments, the framework can offer collaborative features, enabling teams to review documents collectively. The audio feedback can be shared among team members, facilitating group discussions on necessary revisions. Additionally, the framework may incorporate speech-to-text functionalities, allowing users to dictate responses or modifications while listening to the recommendations. This capability streamlines the review process, reducing the need for extensive manual revisions.

In some embodiments, the framework can ensure security and confidentiality when processing sensitive documents. Encrypted storage and access controls prevent unauthorized viewing of document content, while offline processing options allow users to analyze files without uploading them to cloud-based servers. These security measures make the framework suitable for handling confidential business reports, legal contracts, and other sensitive materials.

Overall, the integration of document processing applications with intelligent, audio-based feedback mechanisms revolutionizes the way users interact with editing recommendations. By providing flexible, on-the-go access to document analysis through scheduled or on-demand audio output, the framework empowers users to refine their writing efficiently, even in busy or mobile environments. Through continuous learning, customization, and multimodal delivery, the framework enhances writing quality while ensuring accessibility and convenience across various professional and personal contexts.

Accordingly, the disclosed computerized framework can provide customized and/or personalized advancements in the manner in which documents can be drafted, edited, revised and/or otherwise curated for the purposes of providing a formal output document that adheres to an author's preferred formatting and context/content settings/preferences.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   identifying, by an application, an electronic document, the electronic document comprising content;
   determining, by the application, a model based on information related to the electronic document, the model being a specifically trained executable computer model for analyzing the content;
   analyzing, by the application, the electronic document via execution of the model; determining, by the application, based on the analysis, a set of outputs, the set of outputs comprising recommendations for modifying the content of the electronic document; and
   updating, by the application, the electronic document based on interaction with the electronic document in accordance with the recommendations.
Aspect 2. The method of aspect 1, further comprising the recommendations corresponding to suggested modifications to at least a portion of the content.
Aspect 3. The method of aspect 1, further comprising the recommendations corresponding to automatically performed modifications to at least a portion of the content.
Aspect 4. The method of aspect 1, further comprising:
   analyzing the electronic document;
   determining document information related to the electronic document; and
   performing the determination of the model based on the document information.
Aspect 5. The method of aspect 1, further comprising the document information being selected from a group consisting of: an identifier (ID), author ID, reviewer ID, document type, category of content, date, location, time, length, language, tense, prose, tone, sentiment, age appropriateness and context of the content.
Aspect 6. The method of aspect 1, further comprising:
   identifying a set of models, each model being at least one of an artificial intelligence (AI) model, machine learning (ML) model or large language model (LLM);
   selecting training data from storage; and
   training the set of models based on the training data, wherein the determined model is selected from the set of trained models based on its correspondence to the content of the electronic document.
Aspect 7. The method of aspect 1, further comprising:
   causing display of a modified version of the electronic document based on the determined set of outputs, the modified version being displayed with interactive elements related to the recommendations.
Aspect 8. The method of aspect 1, further comprising:
   generating, based on the set of outputs, a summary, the summary comprising information relaying a context of the recommendations; and
   causing display of the summary in relation to a display of the electronic document.
Aspect 9. The method of aspect 1, further comprising the application comprising functionality for execution of the model, the application being a word processing application, and the model is operational as part of execution of the word processing application.
Aspect 10. The method of aspect 1, further comprising the determination of the model and execution of the model being based on a request for the electronic document to be reviewed.
Aspect 11. The method of aspect 1, further comprising the content being text.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by an application, an electronic document, the electronic document comprising content;
determining, by the application, a model based on information related to the electronic document, the model being a specifically trained executable computer model for analyzing the content;
analyzing, by the application, the electronic document via execution of the model;
determining, by the application, based on the analysis, a set of outputs, the set of outputs comprising recommendations for modifying the content of the electronic document; and
updating, by the application, the electronic document based on interaction with the electronic document in accordance with the recommendations.

2. The method of claim 1, further comprising:
converting, by the application, the set of outputs into an audio format using text-to-speech technology to generate spoken recommendations;
structuring the audio format to include contextual explanations for each recommendation, wherein the contextual explanations provide reasoning behind the recommendations; and
outputting the audio format through at least one of a personal assistant device, mobile application, or smart speaker to enable hands-free review of the recommendations.

3. The method of claim 1, further comprising the recommendations corresponding to suggested modifications to at least a portion of the content.

4. The method of claim 1, further comprising the recommendations corresponding to automatically performed modifications to at least a portion of the content.

5. The method of claim 1, further comprising:
analyzing the electronic document;
determining document information related to the electronic document; and
performing the determination of the model based on the document information.

6. The method of claim 1, further comprising the document information being selected from a group consisting of: an identifier (ID), author ID, reviewer ID, document type, category of content, date, location, time, length, language, tense, prose, tone, sentiment, age appropriateness and context of the content.

7. The method of claim 1, further comprising:
identifying a set of models, each model being at least one of an artificial intelligence (AI) model, machine learning (ML) model or large language model (LLM);
selecting training data from storage; and
training the set of models based on the training data, wherein the determined model is selected from the set of trained models based on its correspondence to the content of the electronic document.

8. The method of claim 1, further comprising:
causing display of a modified version of the electronic document based on the determined set of outputs, the modified version being displayed with interactive elements related to the recommendations.

9. The method of claim 1, further comprising:
generating, based on the set of outputs, a summary, the summary comprising information relaying a context of the recommendations; and
causing display of the summary in relation to a display of the electronic document.

10. The method of claim 1, further comprising the application comprising functionality for execution of the model, the application being a word processing application, and the model is operational as part of execution of the word processing application.

11. The method of claim 1, further comprising the determination of the model and execution of the model being based on a request for the electronic document to be reviewed.

12. A system comprising:
a processor configured to:
identify, by an application, an electronic document, the electronic document comprising content;
determine, by the application, a model based on information related to the electronic document, the model being a specifically trained executable computer model for analyzing the content;
analyze, by the application, the electronic document via execution of the model;
determine, by the application, based on the analysis, a set of outputs, the set of outputs comprising recommendations for modifying the content of the electronic document; and
update, by the application, the electronic document based on interaction with the electronic document in accordance with the recommendations.

13. The system of claim 12, wherein the processor is further configured to:
convert, by the application, the set of outputs into an audio format using text-to-speech technology to generate spoken recommendations;
structure the audio format to include contextual explanations for each recommendation, wherein the contextual explanations provide reasoning behind the recommendations; and
output the audio format through at least one of a personal assistant device, mobile application, or smart speaker to enable hands-free review of the recommendations.

14. The system of claim 12, wherein the processor is further configured to:
analyze the electronic document;
determine document information related to the electronic document; and
perform the determination of the model based on the document information.

15. The system of claim 12, wherein the processor is further configured to:
generate, based on the set of outputs, a summary, the summary comprising information relaying a context of the recommendations; and
cause display of the summary in relation to a display of the electronic document.

16. A non-transitory computer-readable storage medium tangibly encoded with computer-executable instructions that when executed by a processor, perform a method comprising:
identifying, by an application, an electronic document, the electronic document comprising content;
determining, by the application, a model based on information related to the electronic document, the model being a specifically trained executable computer model for analyzing the content;
analyzing, by the application, the electronic document via execution of the model;
determining, by the application, based on the analysis, a set of outputs, the set of outputs comprising recommendations for modifying the content of the electronic document; and
updating, by the application, the electronic document based on interaction with the electronic document in accordance with the recommendations.

17. The non-transitory computer-readable storage medium of claim 16, further comprising:
converting, by the application, the set of outputs into an audio format using text-to-speech technology to generate spoken recommendations;
structuring the audio format to include contextual explanations for each recommendation, wherein the contextual explanations provide reasoning behind the recommendations; and
outputting the audio format through at least one of a personal assistant device, mobile application, or smart speaker to enable hands-free review of the recommendations.

18. The non-transitory computer-readable storage medium of claim 16, further comprising:
analyzing the electronic document;
determining document information related to the electronic document; and
performing the determination of the model based on the document information.

19. The non-transitory computer-readable storage medium of claim 16, further comprising:
causing display of a modified version of the electronic document based on the determined set of outputs, the modified version being displayed with interactive elements related to the recommendations.

20. The non-transitory computer-readable storage medium of claim 16, further comprising:
generating, based on the set of outputs, a summary, the summary comprising information relaying a context of the recommendations; and
causing display of the summary in relation to a display of the electronic document.
